(19) United States
(12) Patent Application Publication
(10) Pub. No.: US 2026/0358137 A1
(43) Pub. Date: Nov. 12, 2026

(54) TRAJECTORY PREDICTION METHOD, APPARATUS, AND VEHICLE

(71) Applicant: Chongqing Changan Technology Co., Ltd., Chongqing (CN)

(72) Inventors: Dongfang YANG, Chongqing (CN); Shuoxian LI, Chongqing (CN); Lecheng XIE, Chongqing (CN); Haoyu LI, Chongqing (CN); Jing LIAN, Chongqing (CN)

(73) Assignee: Chongqing Changan Technology Co., Ltd., Chongqing (CN)

(21) Appl. No.: 19/717,614

(22) Filed: Jun. 23, 2026

Related U.S. Application Data
(63) Continuation of application No. PCT/CN2025/123761, filed on Sep. 24, 2025.

(30) Foreign Application Priority Data
Jan. 21, 2025 (CN) 202510095366.X

(51) Int. Cl. G01C 21/00

(52) U.S. Cl. CPC G01C 21/3833

(57) ABSTRACT

A trajectory prediction method and apparatus, and a vehicle, where the method includes: acquiring a first position sequence feature and a lane segment sequence feature of a to-be-predicted vehicle; the first position sequence feature being used to characterize position features of the to-be-predicted vehicle at a plurality of historical time points and the lane segment sequence feature being used to characterize a positional relationship between the to-be-predicted vehicle and surrounding lane segments; performing an attention mechanism operation based on the first position sequence feature and the lane segment sequence feature to obtain a first lane segment fused feature; and obtaining a predicted trajectory of the to-be-predicted vehicle based on the first lane segment fused feature. Accordingly, the present application can improve the accuracy of the predicted trajectory.

### CROSS-REFERENCE TO RELATED APPLICATIONS

This application is a continuation of International Application No. PCT/CN2025/123761, filed on Sep. 24, 2025, which claims priority to the Chinese patent application No. 202510095366.X, filed with the China National Intellectual Property Administration on Jan. 21, 2025, entitled “Trajectory Prediction Method, Apparatus, and Vehicle”. The disclosures of the aforementioned applications are hereby incorporated by reference in their entireties.

### TECHNICAL FIELD

The present application relates to the field of automotive technology, in particular to the field of vehicle trajectory prediction technology, and specifically relates to a trajectory prediction method and apparatus, and a vehicle.

### BACKGROUND

As leaders in the transformation and upgrading of the vehicle industry, autonomous vehicles have gained worldwide attention and recognition, which is self-evident. The core of this technology lies in enabling vehicles to make accurate and timely decisions in various complex traffic environments, so as to ensure driving safety and efficiency. To achieve this goal, it is particularly important to predict in advance the intentions or motion trajectories of surrounding vehicles to be predicted (such as other vehicles, pedestrians and the like).

In related technologies, the proposed Multi-PPTP adopts the lightweight Mobile Net network as a feature encoder for grid maps. However, it fails to effectively exploit the sparsity of traffic scene information, leading to inaccurate predicted trajectories.

In related technologies, a method for extracting vehicle trajectory features is proposed to provide standardized feature data for vehicle trajectory classification or prediction. However, the introduction of sampling increases the uncertainty of the encoding process and leads to inaccurate predicted trajectories.

### SUMMARY

The present application provides a trajectory prediction method and apparatus, and a vehicle, to at least solve the technical problem in related technologies of low feasibility of trajectory prediction. The technical solution of the present application is as follows:

According to a first aspect provided by the present application, a trajectory prediction method is provided. The method includes: acquiring a first position sequence feature and a lane segment sequence feature of a to-be-predicted vehicle, where the first position sequence feature is used to characterize position features of the to-be-predicted vehicle at a plurality of historical time points, and the lane segment sequence feature is used to characterize a positional relationship between the to-be-predicted vehicle and surrounding lane segments; performing an attention mechanism operation based on the first position sequence feature and the lane segment sequence feature to obtain a first lane segment fused feature; and obtaining a predicted trajectory of the to-be-predicted vehicle based on the first lane segment fused feature.

Based on the above technical solution, the embodiments of the present application integrate multi-dimensional information (the first position sequence feature and the lane segment sequence feature) and apply the attention mechanism operation, enabling the model to automatically learn and emphasize the position sequence feature and the lane segment sequence feature that have a significant impact on the prediction result, thereby improving the accuracy and robustness of the predicted trajectory.

In some embodiments, obtaining a predicted trajectory of a to-be-predicted vehicle based on a first lane segment fused feature includes: acquiring a vehicle interaction feature and a second lane segment fused feature corresponding to a surrounding vehicle of the to-be-predicted vehicle, where the vehicle interaction feature is used to characterize a positional relationship between the to-be-predicted vehicle and the surrounding vehicle; performing an attention mechanism operation based on the first lane segment fused feature, the vehicle interaction feature, and the second lane segment fused feature to obtain a target fused feature; and generating the predicted trajectory of the to-be-predicted vehicle according to the target fused feature.

Based on the above technical solution, the embodiments of the present application further integrate, on the basis of the lane segment sequence feature, the second lane segment fused feature corresponding to the surrounding vehicle and the vehicle interaction feature. This can accurately characterize the relative positions and dynamic relationships between the to-be-predicted vehicle and surrounding vehicles. Through the attention mechanism operation, the model is able to better understand behavior patterns of the vehicle in complex traffic scenarios, thereby generating more reliable predicted trajectories.

In some embodiments, acquiring a first position sequence feature of a to-be-predicted vehicle includes: acquiring historical position information of the to-be-predicted vehicle; processing the historical position information based on a first multi-layer perceptron (MLP) to obtain a second position sequence feature of the to-be-predicted vehicle; fusing the second position sequence feature with a time embedding parameter to obtain a third position sequence feature; and performing an attention mechanism operation on the third position sequence feature to obtain the first position sequence feature.

Based on the above technical solution, the embodiments of the present application use a first multi-layer perceptron (MLP) to process historical position information, enabling the extraction of deep-level features of vehicle motion (the second position sequence feature). This second position sequence feature helps to more accurately predict the future position of the vehicle. Additionally, the introduction of a time embedding parameter allows the model to take into account the influence of temporal factors, further improving prediction accuracy.

In some embodiments, obtaining a lane segment sequence feature of a to-be-predicted vehicle includes: acquiring surrounding lane segment position information of the to-be-predicted vehicle; and processing the surrounding lane segment position information based on a second multi-layer perceptron (MLP) to obtain the lane segment sequence feature.

Based on the above technical solution, the embodiments of the present application process the surrounding lane segment position information through a second multi-layer perceptron (MLP), enabling efficient extraction of key features of the lane segments. As a type of feedforward neural network, the second multi-layer perceptron (MLP) has strong nonlinear fitting capabilities, allowing it to learn the complex relationship between lane segment position information and vehicle motion. This enables the model to better understand the structure and constraints of lane segments in subsequent position prediction or trajectory planning.

In some embodiments, performing an attention mechanism operation based on the first position sequence feature and the lane segment sequence feature to obtain a first lane segment fused feature includes: mapping the first position sequence feature into a first query vector based on a third multi-layer perceptron (MLP); mapping a first concatenated feature into a first key vector and a first value vector based on a fourth multi-layer perceptron (MLP), where the first concatenated feature is obtained by concatenating the first position sequence feature and the lane segment sequence feature; and performing the attention mechanism operation based on the first query vector, the first key vector and the first value vector to obtain the first lane segment fused feature.

Based on the above technical solution, the embodiments of the present application use the third multi-layer perceptron (MLP) and the fourth multi-layer perceptron (MLP) to flexibly map the first position sequence feature and the lane segment sequence feature into a query vector, a key vector, and a value vector in a high-dimensional space. This mapping approach preserves important information from the original features while reducing redundancy and noise. Moreover, through the attention mechanism, the model can dynamically adjust the weights of different features during the fusion process based on the similarity between the query and key vectors, enabling the trajectory prediction model to more accurately understand the relationship between the first position sequence feature and the lane segment sequence feature, thereby generating the first lane segment fused feature.

In some embodiments, acquiring a vehicle interaction feature includes: acquiring surrounding vehicle position information of the to-be-predicted vehicle; and processing the surrounding vehicle position information based on a fifth multi-layer perceptron (MLP) to obtain the vehicle interaction feature.

Based on the above technical solution, the embodiments of the present application can establish a connection relationship between the to-be-predicted vehicle and surrounding vehicles at the current moment, and extract edge features using embedding representations and relative coordinates, thereby achieving the construction of global interaction encoding. This method can accurately capture the dynamic interaction relationships among vehicles, providing effective technical support for intelligent processing in fields such as intelligent transportation and autonomous driving.

In some embodiments, performing an attention mechanism operation based on the first lane segment fused feature, the vehicle interaction feature, and the second lane segment fused feature to obtain a target fused feature includes: mapping the first lane segment fused feature into a second query vector based on a sixth multi-layer perceptron (MLP); mapping a second concatenated feature into a second key vector and a second value vector based on a seventh multi-layer perceptron (MLP), where the second concatenated feature is obtained by concatenating the first lane segment fused feature, the vehicle interaction feature, and the second lane segment fused feature; and performing the attention mechanism operation based on the second query vector, the second key vector, and the second value vector to obtain the target fused feature.

According to a second aspect provided by the present application, a training method for a trajectory prediction model is provided. The method includes: acquiring a first position sequence feature and a lane segment sequence feature of a vehicle at a first sample time point, where the first position sequence feature characterizes positions of the vehicle at a plurality of historical time points before the first sample time point, and the lane segment sequence feature characterizes a positional relationship between the vehicle and surrounding lane segments at the plurality of historical time points; acquiring a target lane segment ground-truth label and a true trajectory corresponding to the vehicle at a second sample time point; processing the first position sequence feature and the lane segment sequence feature based on the trajectory prediction model to obtain a predicted lane segment label and a predicted trajectory corresponding to the second sample time point, where the trajectory prediction model is configured to perform an attention mechanism operation based on the first position sequence feature and the lane segment sequence feature to obtain a first lane segment fused feature, obtain the predicted trajectory based on the first lane segment fused feature, and determine the predicted lane segment label corresponding to the predicted trajectory; calculating a first loss based on the target lane segment ground-truth label and the predicted lane segment label; calculating a second loss based on the true trajectory and the predicted trajectory; and adjusting the trajectory prediction model according to the first loss and the second loss.

Based on the above technical solution, the embodiments of the present application comprehensively consider the vehicle's historical position information and its positional relationship with surrounding lane segments. These two types of features jointly contribute to trajectory prediction, enabling a more comprehensive reflection of the vehicle's driving state and possible paths. Furthermore, through the attention mechanism operation, the model can dynamically adjust the weights of different features during the prediction process, thereby more accurately capturing key information of vehicle driving and improving prediction accuracy.

In some embodiments, acquiring the first position sequence feature and the lane segment sequence feature of the vehicle at the first sample time point includes: acquiring historical position information of the vehicle at the plurality of historical time points and surrounding lane segment position information of a to-be-predicted vehicle at the plurality of historical time points; and processing the historical position information and the surrounding lane segment position information based on the trajectory prediction model to obtain the first position sequence feature and the lane segment sequence feature, respectively.

In some embodiments, the method further includes: acquiring a vehicle interaction feature of the vehicle and a second lane segment fused feature corresponding to a surrounding vehicle of the vehicle, where the vehicle interaction feature is used to characterize a positional relationship between the vehicle and the surrounding vehicle at the first sample time point; processing the first position sequence feature and the lane segment sequence feature based on the trajectory prediction model to obtain the predicted lane segment label and the predicted trajectory corresponding to the second sample time point includes: processing the first lane segment fused feature, the vehicle interaction feature, and the second lane segment fused feature based on the trajectory prediction model to obtain the predicted lane segment label and the predicted trajectory corresponding to the second sample time point, where the trajectory prediction model is configured to perform an attention mechanism operation based on the first position sequence feature and the lane segment sequence feature to obtain the first lane segment fused feature, perform an attention mechanism operation based on the first lane segment fused feature, the vehicle interaction feature, and the second lane segment fused feature to obtain a target fused feature, generate the predicted trajectory of the vehicle according to the target fused feature, and determine the predicted lane segment label corresponding to the predicted trajectory.

According to a third aspect provided by the present application, a vehicle is provided, including a trajectory prediction apparatus.

According to a fourth aspect provided by the present application, an electronic device is provided, including: a processor and a memory for storing processor-executable instructions. The processor is configured to execute the instructions to implement the method of the first aspect or any of its possible implementations.

According to a fifth aspect provided by the present application, a computer-readable storage medium is provided. When instructions in the computer-readable storage medium are executed by a processor of an electronic device, the electronic device is enabled to perform the method of the first aspect or any of its possible implementations.

According to a sixth aspect provided by the present application, a computer program product is provided. The computer program product includes computer instructions that, when executed on an electronic device, cause the electronic device to perform the method of the first aspect or any of its possible implementations.

Therefore, the above technical features of the present application have the following beneficial effects:

(1) The embodiments of the present application integrate multi-dimensional information (the first position sequence feature and the lane segment sequence feature) and apply the attention mechanism operation, enabling the model to automatically learn and emphasize the position sequence feature and the lane segment sequence feature that have a significant impact on the prediction result, thereby improving prediction accuracy and robustness.

(2) The embodiments of the present application further integrate, on the basis of the lane segment sequence feature, the second lane segment fused feature corresponding to the surrounding vehicle and the vehicle interaction feature. This can accurately characterize the relative positions and dynamic relationships between the to-be-predicted vehicle and surrounding vehicles. Through the attention mechanism operation, the model is able to better understand behavior patterns of the vehicle in complex traffic scenarios, thereby generating more reliable predicted trajectories.

(3) The embodiments of the present application use a first multi-layer perceptron (MLP) to process historical position information, enabling the extraction of deep-level features of vehicle motion (the second position sequence feature). This second position sequence feature helps to more accurately predict the future position of the vehicle. Additionally, the introduction of a time embedding parameter allows the model to take into account the influence of temporal factors, further improving prediction accuracy.

(4) The embodiments of the present application process the surrounding lane segment position information through a second multi-layer perceptron (MLP), enabling efficient extraction of key features of the lane segments. As a type of feedforward neural network, the second multi-layer perceptron (MLP) has strong nonlinear fitting capabilities, allowing it to learn the complex relationship between lane segment position information and vehicle motion. This enables the model to better understand the structure and constraints of lane segments in subsequent position prediction or trajectory planning.

(5) The embodiments of the present application use the third multi-layer perceptron (MLP) and the fourth multi-layer perceptron (MLP) to flexibly map the first position sequence feature and the lane segment sequence feature into a query vector, a key vector, and a value vector in a high-dimensional space. This mapping approach preserves important information from the original features while reducing redundancy and noise. Moreover, through the attention mechanism, the model can dynamically adjust the weights of different features during the fusion process based on the similarity between the query and key vectors, enabling the trajectory prediction model to more accurately understand the relationship between the first position sequence feature and the lane segment sequence feature, thereby generating the first lane segment fused feature.

(6) The embodiments of the present application establish a connection relationship between the to-be-predicted vehicle and surrounding vehicles at the current moment, and extract edge features using embedding representations and relative coordinates, thereby achieving the construction of global interaction encoding. This method can accurately capture the dynamic interaction relationships among vehicles, providing effective technical support for intelligent processing in fields such as intelligent transportation and autonomous driving.

(7) The embodiments of the present application comprehensively consider the vehicle's historical position information and its positional relationship with surrounding lane segments. These two types of features jointly contribute to trajectory prediction, enabling a more comprehensive reflection of the vehicle's driving state and possible paths. Furthermore, through the attention mechanism operation, the model can dynamically adjust the weights of different features during the prediction process, thereby more accurately capturing key information of vehicle driving and improving prediction accuracy.

It should be noted that the technical effects brought about by any of the implementation methods of the second to sixth aspects can be found in the technical effects brought about by the corresponding implementation manners of the first aspect, and will not be repeated here.

It should be understood that the above general description and the following detailed description are merely exemplary and explanatory and are not intended to limit the present application.

### BRIEF DESCRIPTION OF DRAWINGS

The accompanying drawings, which are incorporated in and constitute a part of this specification, illustrate embodiments consistent with the present application and, together with the description, serve to explain the principles of the present application, without constituting any undue limitation on the present application.

FIG. 1 is a schematic structural diagram of a vehicle according to an exemplary embodiment.

FIG. 2 is a block diagram of a trajectory prediction apparatus according to an exemplary embodiment.

FIG. 3 is a schematic flowchart of a trajectory prediction method according to an exemplary embodiment.

FIG. 4 is a scenario diagram of a trajectory prediction method according to an exemplary embodiment.

FIG. 5 is a scenario diagram of another trajectory prediction method according to an exemplary embodiment.

FIG. 6 is a scenario diagram of another trajectory prediction method according to an exemplary embodiment.

FIG. 7 is a scenario diagram of another trajectory prediction method according to an exemplary embodiment.

FIG. 8 is a scenario diagram of another trajectory prediction method according to an exemplary embodiment.

FIG. 9 is a block diagram of another trajectory prediction apparatus according to an exemplary embodiment.

FIG. 10 is a block diagram of an electronic device according to an exemplary embodiment.

### DETAILED DESCRIPTION OF EMBODIMENTS

In order to enable a person of ordinary skill in the art to better understand the technical solutions of the present application, the technical solutions in the embodiments of the present application will be clearly and completely described below with reference to the accompanying drawings.

It should be noted that the terms “first”, “second”, and the like in the specification and claims of the present application and the above-mentioned drawings are used to distinguish similar objects and are not necessarily used to describe a specific order or sequence. It should be understood that the data so used may be interchanged under appropriate circumstances, so that the embodiments of the present application described herein can be implemented in an order other than those illustrated or described herein. The implementations described in the following exemplary embodiments are not intended to represent all implementations consistent with the present application. On the contrary, they are merely examples of devices and methods consistent with certain aspects of the present application as detailed in the appended claims.

In the embodiments of the present application, terms such as “exemplary”, “for example”, or “such as” are used to indicate examples, illustrations, or explanations. Any embodiment or design described as “exemplary”, “for example”, or “such as” in the embodiments of the present application should not be construed as being more advantageous than other embodiments or designs. Rather, the use of terms such as “exemplary”, “for example”, or “such as” is intended to present related concepts in a concrete manner.

First, the relevant technologies involved in the present application are explained to facilitate understanding by those skilled in the art.

In recent years, the widespread application of deep neural networks in the field of trajectory prediction has indeed brought significant progress to areas such as autonomous driving and intelligent transportation. Among them, goal-driven trajectory prediction methods decompose the problem into two subtasks: predicting possible goals and performing motion estimation based on contextual features, thereby achieving more accurate predictions of a vehicles' future trajectories. However, while pursuing low prediction errors, these methods often overlook the physical feasibility of the predicted trajectories, which is an issue worth further investigation.

To address the above issue, a more complex trajectory representation method may be adopted to more comprehensively describe the vehicle's occupancy in space, thereby generating a predicted trajectory of the vehicle and overcoming the problem of low feasibility. This method can more accurately reflect the actual space occupied by the vehicle, thus improving the physical feasibility of the prediction results.

In summary, although deep learning-based trajectory prediction methods have achieved significant results in reducing prediction errors, physical feasibility remains one of the key factors limiting their practical application. In the future, researchers need to introduce more physical constraints and more complex trajectory representation methods into prediction models to ensure that the generated predicted trajectories are both accurate and feasible. This will provide a more reliable foundation for the practical application of intelligent transportation systems such as autonomous driving.

The technical solutions in the embodiments of the present application will be described below with reference to the accompanying drawings in the embodiments of the present application. Obviously, the described embodiments are only a part of the embodiments of the present application, rather than all of the embodiments.

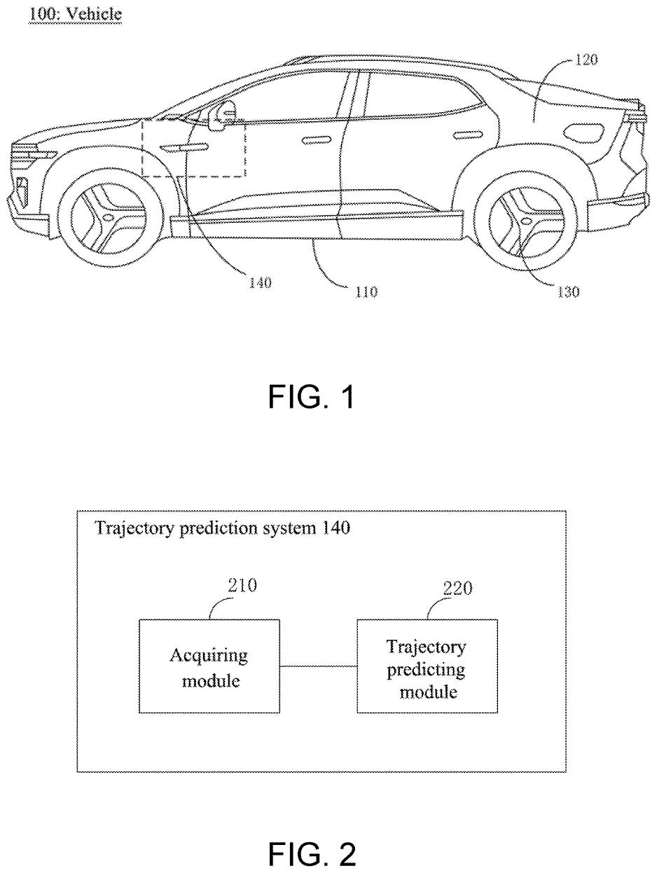

The trajectory prediction method provided in the embodiments of the present application may be applied in a vehicle. As shown in FIG. 1, which is a schematic structural diagram of a vehicle provided in an embodiment of the present application, the vehicle 100 may include a chassis 110, a body 120, and wheels 130. It can be understood that the vehicle 100 may be a fuel vehicle, an electric vehicle, a hybrid electric vehicle, a gas vehicle, a methanol vehicle, a solar vehicle, or the like.

Exemplarily, the vehicle 100 may be a passenger car such as a sedan, a sport utility vehicle (SUV), or a multi-purpose vehicle (MPV), or may be a bus, a truck, a semi-trailer, or the like. The present application does not impose specific limitations in this regard.

It can be understood that the above components are merely examples of a portion of the components of the vehicle 100 and are not intended to limit the specific structure of the vehicle 100.

In an implementation, to control the vehicle, the vehicle 100 may further include a trajectory prediction system 140. The trajectory prediction system 140 can predict the motion trajectories of surrounding vehicles to be predicted around the vehicle 100.

As shown in FIG. 2, an embodiment of the present application provides a block diagram of a trajectory prediction system 140. The trajectory prediction system 140 includes an acquiring module 210 and a trajectory predicting module 220.

The acquiring module 210 is configured to acquire a first position sequence feature and a lane segment sequence feature of a to-be-predicted vehicle, and send the first position sequence feature and the lane segment sequence feature to the trajectory predicting module 220.

In some embodiments, the first position sequence feature is used to characterize position features of the to-be-predicted vehicle at a plurality of historical time points, and the lane segment sequence feature is used to characterize a positional relationship between the to-be-predicted vehicle and surrounding lane segments.

The trajectory predicting module 220 is configured to perform an attention mechanism operation based on the first position sequence feature and the lane segment sequence feature to obtain a first lane segment fused feature, and obtain a predicted trajectory of the to-be-predicted vehicle based on the first lane segment fused feature.

It should be noted that the trajectory prediction system described in the embodiments of the present application is intended to illustrate the technical solutions of the embodiments of the present application more clearly and does not constitute a limitation on the technical solutions provided in the embodiments of the present application. A person of ordinary skill in the art will appreciate that, with the evolution of electronic devices and the emergence of other electronic devices, the technical solutions provided in the embodiments of the present application are equally applicable to similar technical problems. The methods in the following embodiments can all be implemented in a trajectory prediction system with the above hardware structure.

The methods in the following embodiments can all be implemented in a trajectory prediction system with the above hardware structure.

The trajectory prediction method provided in the embodiments of the present application will be described in detail below with reference to the accompanying diagrams.

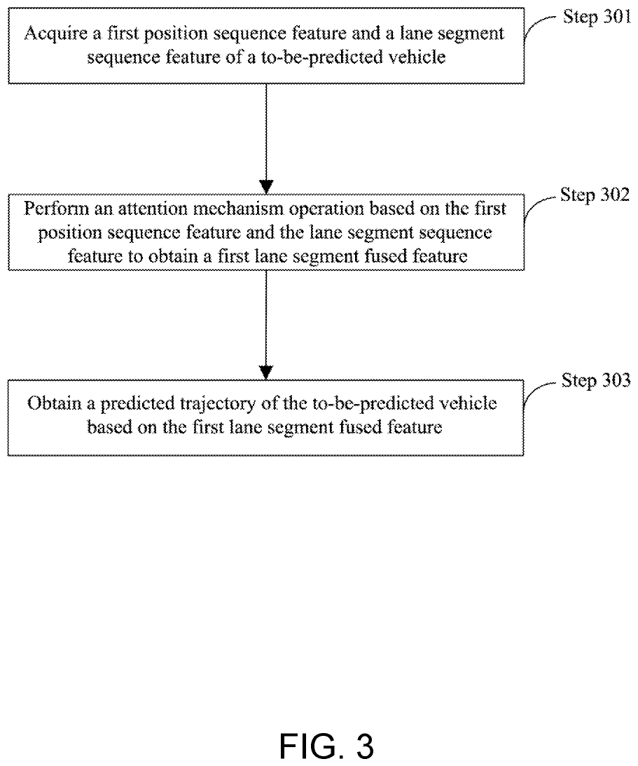

The trajectory prediction method in the embodiments of the present application can be applied to predicting the motion trajectory of a to-be-predicted vehicle. As shown in FIG. 3, the trajectory prediction method may include steps 301 to 303. Among them, step 301 may also be referred to as the process of “acquiring a first position sequence feature and a lane segment sequence feature of a to-be-predicted vehicle,” and steps 302 to 303 may be referred to as the process of “generating a predicted trajectory of the to-be-predicted vehicle.” Steps 301 to 303 are described in detail below.

Step 301: acquire a first position sequence feature and a lane segment sequence feature of the to-be-predicted vehicle.

In embodiments related to the present application, the first position sequence feature is used to characterize position features of the to-be-predicted vehicle at a plurality of historical time points, and the lane segment sequence feature is used to characterize a positional relationship between the to-be-predicted vehicle and surrounding lane segments.

In some embodiments, the trajectory prediction system may acquire historical position information of the to-be-predicted vehicle, process the historical position information based on a first multi-layer perceptron (MLP) to obtain a second position sequence feature of the to-be-predicted vehicle, then fuse the second position sequence feature with a time embedding parameter to obtain a third position sequence feature, and perform an attention mechanism operation on the third position sequence feature to obtain the first position sequence feature.

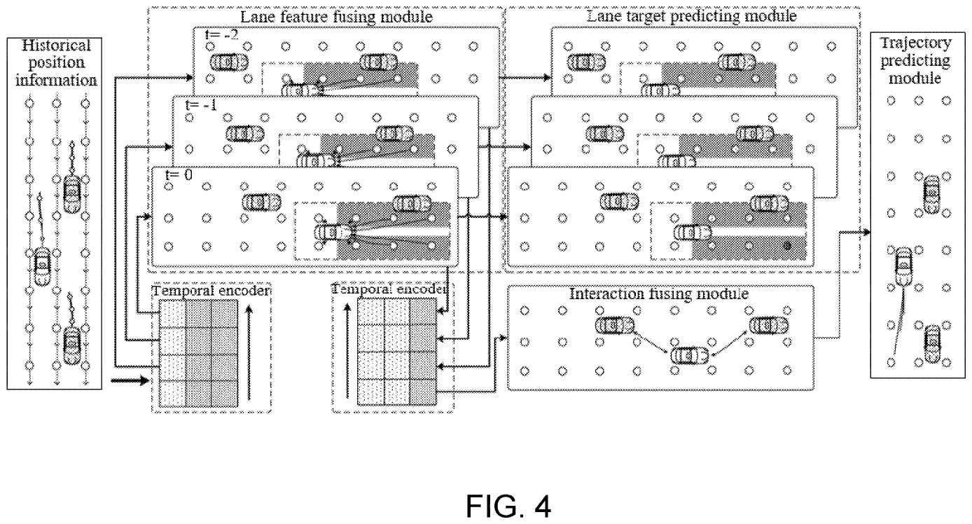

Exemplarily, as shown in FIG. 4, the trajectory prediction system may acquire historical position information (Hᵢ, t) of the to-be-predicted vehicle. Each historical position information includes, but is not limited to, a timestamp and coordinate values of the to-be-predicted vehicle, where t represents different historical timestamps (t=0, t=−1, t=−2), and i represents the i-th to-be-predicted vehicle.

Subsequently, the trajectory prediction system may check whether the timestamp corresponding to the historical position information Hᵢ, t of the to-be-predicted vehicle is valid. For position information with invalid timestamps (e.g., missing, incorrect format, etc.) or that is significantly abnormal compared to other historical position information (e.g., an excessively large time jump), such information is regarded as an invalid position, and its corresponding coordinate values are set to zero to avoid their influence in subsequent analysis.

For valid position data, the coordinate increment ΔHᵢ, t between adjacent position information (e.g., with a step size of 1) is calculated, i.e., Δx=x(t+1)−x(t) and Δy=y(t+1)−y(t) (or Δz in three-dimensional space), to represent the instantaneous direction and instantaneous velocity information of the to-be-predicted vehicle.

In addition, for the instantaneous velocity information, the timestamp information may also be combined to calculate the moving distance of the to-be-predicted vehicle between adjacent positions, and the moving distance is divided by the time interval to obtain the instantaneous velocity information. The calculated instantaneous direction and instantaneous velocity information are then output for use in subsequent applications such as path planning, obstacle avoidance, and navigation.

Thus, the embodiments of the present application effectively improve the accuracy of the instantaneous direction and instantaneous velocity information of the to-be-predicted vehicle through the timestamp validity check and invalid position data processing mechanism. At the same time, using coordinate increments with a step size of 1 to represent the motion state of the to-be-predicted vehicle provides reliable data support for motion analysis and control of the to-be-predicted vehicle.

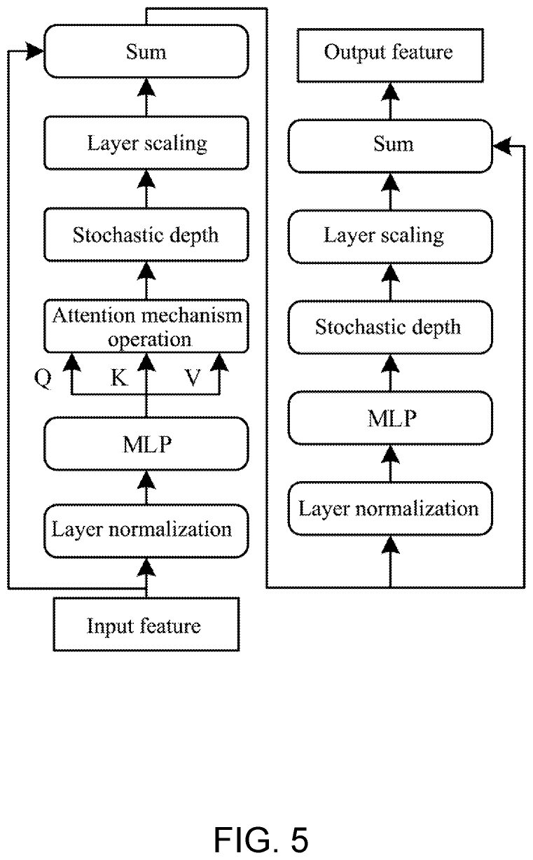

In an implementation, as shown in FIG. 5, the embodiments of the present application may construct a temporal encoder using a Transformer model, and compute self-attention features and fully-connected features respectively by constructing two residual modules.

Further, the trajectory prediction system may project, using a first multilayer perceptron (multilayer perceptron, MLP), the coordinate increment ΔHᵢ, t into a feature space of dimension d as the second position sequence feature e_{i,t}.

Furthermore, the embodiments of the present application may initialize a set of learnable parameters as a time embedding, the length of the time embedding equals a time step of the historical position information of the to-be-predicted vehicle, and concatenate the initialized time embedding with the second position sequence feature. The concatenation operation may be performed in the feature dimension, i.e., using the time embedding as an additional dimension of features of the to-be-predicted vehicle.

Subsequently, a dimension transformation is performed on the concatenated feature to meet the requirements for subsequent processing of the trajectory prediction model. After the initialization of the time embedding, feature concatenation, and dimension transformation, a third position sequence feature containing temporal information is obtained. The dimension transformation may include adjusting the shape of the feature, performing a linear transformation, etc.

It should be understood that the dimension of the time embedding can be set according to specific task requirements, and the parameters of the time embedding will be continuously optimized during the subsequent training process of the model to better capture temporal information.

Furthermore, the third position sequence feature is mapped into a query vector (Query) feature, a key vector (Key) feature, and a value vector (Value) feature through layer normalization and the first multi-layer perceptron, as shown in Formula 1 below:

{Qₜ,Kₜ,Vₜ}={φ_{Q}(e_{i,t}),φ_{K}(e_{i,t}),φ_{V}(e_{i,t})} Formula 1;
where φ_{Q}(e_{i,t}) denotes the query vector (Query) feature mapped from the third position sequence feature, φ_{K}(e_{i,t}) denotes the key vector (Key) feature mapped from the third position sequence feature, and φ_{V}(e_{i,t}) denotes the value vector (Value) feature mapped from the third position sequence feature.

The first position sequence feature is obtained through calculation using the self-attention mechanism, as shown in Formula 2 below:

$${e}_{{att}_{i , {t}_{1}}} = att ( {Q}_{{t}_{1}}^{T} {K}_{{t}_{2}} ) ; \qquad Formula 2$$

where

$${e}_{{att}_{i , {t}_{1}}}$$

denotes the first position sequence feature, i denotes the i-th to-be-predicted vehicle, t₁ and t₂ denote different historical time points,

$${Q}_{{t}_{1}}^{T}$$

denotes the transpose of a query vector (Query) feature matrix of the to-be-predicted vehicle at time t₁, T denotes matrix transpose, and Kₜ_{₂} denotes a key vector (Key) feature matrix of the to-be-predicted vehicle at time t₂.

In an implementation, as shown in FIG. 5, the trajectory prediction system may adopt multi-head attention for stable training, i.e., Q (query vector (Query) features), K (key vector (Key) features), and V (value vector (Value) features) are divided into g groups, so the batch size is enlarged by a factor of g. The dimension of features in each group is 1/g. After the attention calculation is completed, the multi-head features are concatenated to obtain the final attention feature.

Further, the attention feature is sequentially transformed through layer normalization and a multi-layer perceptron to obtain a fully-connected feature, as shown in Formula 3 below:

$${e}_{{ffn}_{i , {t}_{1}}} = {ϕ}_{ffn} ( {e}_{{att}_{i , {t}_{1}}} + {e}_{i , {t}_{1}} ) ; \qquad Formula 3$$

where

$${e}_{{ffn}_{i , {t}_{1}}}$$

denotes the fully-connected feature, and

$${e}_{{att}_{i , {t}_{1}}}$$

denotes the first position sequence feature.

Furthermore, a residual connection is introduced to obtain a new feature of the to-be-predicted vehicle, as shown in Formula 4 below:

e_{i,t}_{₁}=eatt_{i,t}_{₂}+e_{i,t}+effn_{i,t}_{₁} Formula 4;
where e_{i,t}_{₁} denotes the first position sequence feature,

$${e}_{{att}_{i , {t}_{2}}}$$

denotes the position sequence feature obtained by the self-attention mechanism, e_{i,t} denotes the second position sequence feature, and

$${e}_{{ffn}_{i , {t}_{1}}}$$

denotes the fully-connected feature.

To reduce the overfitting effect, stochastic depth and layer scaling are introduced into the residual connection. Stochastic depth means that the residual connection has a certain probability of being dropped during the training process of the model, and this probability increases as the number of layers increases, as shown in Formula 5 below:

$${p}_{l} = 1 - \frac{l}{L} ( 1 - {p}_{L} ) ; \qquad Formula 5$$

where pₗ is the drop probability of the l-th layer, L is the total number of layers, and p_{L} is the drop probability of the last layer. Layer scaling performs independent scaling on the residual feature of each layer in the feature dimension, enriching the differences across channel features, as shown in Formula 6 below:

e′=wₗₛ·e Formula 6;
where e and e′ are the original and updated residual features, respectively, and wₗₛ is a learnable weight.

It should be understood that, as shown in FIG. 4, the first position sequence feature of the to-be-predicted vehicle is output by the temporal encoder. The temporal encoder encodes the historical state or behavior data of the to-be-predicted vehicle to extract features with temporal characteristics, which represent the state or behavior pattern of the to-be-predicted vehicle at the current moment.

In some embodiments, the trajectory prediction system may acquire surrounding lane segment position information of the to-be-predicted vehicle, and process the surrounding lane segment position information based on a second multi-layer perceptron (MLP) to obtain the lane segment sequence feature.

Exemplarily, the trajectory prediction system may determine, based on the historical position information of the to-be-predicted vehicle, lane segments within a preset distance in the moving direction of the to-be-predicted vehicle (i.e., surrounding lane segments), and process the coordinates of the screened surrounding lane segments according to the second multi-layer perceptron (MLP) to obtain the surrounding lane segment position information.

Further, the surrounding lane segment position information (i.e., the midpoint coordinates of the line segments of the surrounding lane segments) is transformed into the local coordinate system of the to-be-predicted vehicle, so that the midpoint coordinates of the line segments are clearly expressed relative to the position of the to-be-predicted vehicle.

The second multi-layer perceptron is used to process the converted midpoint coordinates of the line segments. Through nonlinear transformation of the input data, the second multi-layer perceptron extracts deep features from the midpoint coordinates of the line segments. These deep features are used as edge features in the graph structure (i.e., the lane segment sequence features).

In an implementation, the embodiments of the present application may combine the lane segment sequence features processed by the second multi-layer perceptron (MLP) with the first position sequence features of the to-be-predicted vehicle to construct a spatiotemporal graph structure between the lane segments and the to-be-predicted vehicle. This spatiotemporal graph structure not only reflects the spatial relationship between the lane segments and the to-be-predicted vehicle, but also incorporates the temporal state information of the to-be-predicted vehicle, thereby achieving a comprehensive description of the environment surrounding the to-be-predicted vehicle.

Through the above method, the embodiments of the present application efficiently construct the relative positional relationship (spatiotemporal graph structure) between the lane segments and the to-be-predicted vehicle, providing strong support for subsequent tasks such as path planning and trajectory prediction.

Step 302: perform an attention mechanism operation based on the first position sequence feature and the lane segment sequence feature to obtain a first lane segment fused feature.

In some embodiments, the trajectory prediction system may map the first position sequence feature into a first query vector based on a third multi-layer perceptron (MLP), and map a first concatenated feature into a first key vector and a first value vector based on a fourth multi-layer perceptron (MLP), and then perform the attention mechanism operation based on the first query vector, the first key vector and the first value vector to obtain the first lane segment fused feature.

Among them, the first concatenated feature is obtained by concatenating the first position sequence feature and the lane segment sequence feature.

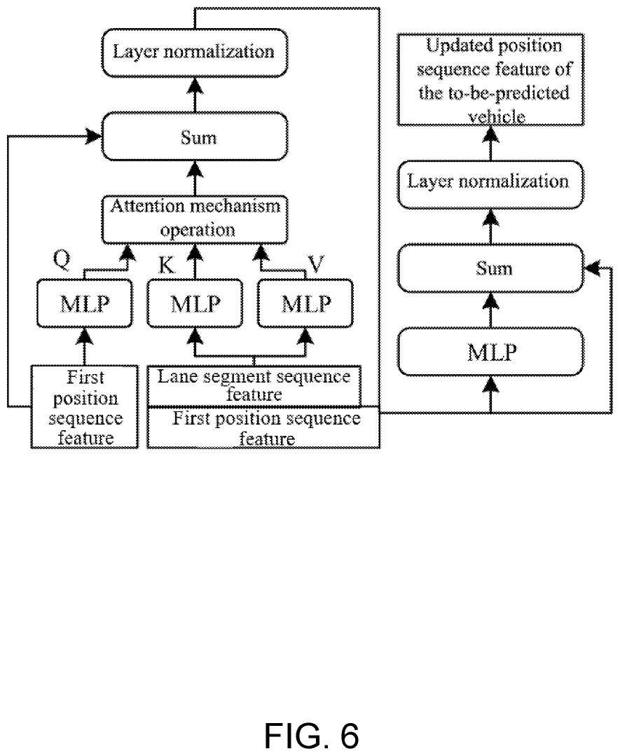

Exemplarily, as shown in FIG. 6, the trajectory prediction system may project the first position sequence feature into a first query vector Q_{i,t} using a third multi-layer perceptron (MLP), and project the first concatenated feature, which is obtained by concatenating the first position sequence feature and the lane segment sequence feature, into a first key vector K_{j,t} and a first value vector V_{j,t} using fourth multi-layer perceptrons (MLP). The number of channels may be d.

As shown in FIG. 4, the attention mechanism of the lane feature fusing module is used to fuse the lane segment sequence feature into the first position sequence feature to obtain the residual feature eᵣₑₛ_{ᵢ}, as shown in Formula 7 below:

eᵣₑₛ_{ᵢ}=att(Q_{i,t}·K_{j,t}) Formula 7;

Further, the trajectory prediction system may concatenate the residual feature eᵣₑₛ_{ᵢ} with the first position sequence feature, followed by normalization and processing by fourth multi-layer perceptrons (MLP), to obtain the updated position sequence feature e′ᵢ of the to-be-predicted vehicle, as shown in Formula 8 below:

e′ⁱ=η₂(φ(η₁(eᵢ+eᵣₑₛ_{ᵢ}))+η₁(eᵢ+eᵣₑₛ_{ᵢ})) Formula 8;
where η₁ and η₂ denote normalization functions, and φ denotes the network structure of the fourth multi-layer perceptron (MLP) of the fully-connected layer.

Through the temporal encoder, the directed lane segment feature is further fused with the node feature of the to-be-predicted vehicle Aᵢ, and the sequence feature e_{i,t}|t=0 of the to-be-predicted vehicle at t=0 is taken as the embedding bᵢ of the to-be-predicted vehicle.

Furthermore, the temporal encoder is used to fuse the lane segment sequence feature with the updated position sequence feature e′ᵢ of the to-be-predicted vehicle. Based on the temporal encoding, the sequence feature e_(i,t)|t=0 of the to-be-predicted vehicle at the specific time t=0 is selected. This feature contains not only the dynamic information of the to-be-predicted vehicle itself, but also the static and dynamic features reflecting the influence exerted by the lane segment sequence feature thereon. This feature is set as the embedding representation bᵢ of the to-be-predicted vehicle. The embedding vector bᵢ can comprehensively and compactly reflect the state of the to-be-predicted vehicle at the initial moment and its interaction with the surrounding environment.

It should be understood that the temporal encoder can capture dynamic changes of time series data and effectively integrate information in the temporal dimension through its internal mechanisms (such as recurrent neural network RNN, long short-term memory LSTM, or gated recurrent unit GRU), thereby generating a new feature set that incorporates spatiotemporal characteristics.

Step 303: obtain a predicted trajectory of the to-be-predicted vehicle based on the first lane segment fused feature.

In some embodiments, the trajectory prediction system may acquire a vehicle interaction feature and a second lane segment fused feature corresponding to a surrounding vehicle of the to-be-predicted vehicle, then perform an attention mechanism operation based on the first lane segment fused feature, the vehicle interaction feature, and the second lane segment fused feature to obtain a target fused feature, and generate the predicted trajectory of the to-be-predicted vehicle according to the target fused feature.

The vehicle interaction feature is used to characterize a positional relationship between the to-be-predicted vehicle and the surrounding vehicle.

Exemplarily, as shown in FIG. 4, the trajectory predicting module of the trajectory prediction system may input the target fused feature into multiple sets of multi-layer perceptrons for decoding to obtain multiple predicted trajectories and a confidence corresponding to each predicted trajectory, and determine the predicted trajectory with the highest confidence among the multiple predicted trajectories as the predicted trajectory of the to-be-predicted vehicle.

In some embodiments, the target fused feature mentioned above may be obtained in the following manner: the trajectory prediction system may map the first lane segment fused feature into a second query vector based on a sixth multi-layer perceptron (MLP), and map a second concatenated feature into a second key vector and a second value vector based on a seventh multi-layer perceptron (MLP), and then perform an attention mechanism operation based on the second query vector, the second key vector, and the second value vector to obtain the target fused feature.

Among them, the second concatenated feature is obtained by concatenating the first lane segment fused feature, the vehicle interaction feature, and the second lane segment fused feature.

Exemplarily, as shown in FIG. 4, the lane target predicting module of the trajectory prediction system may project the first lane segment fused feature into a second query vector Q_{i,t} using a sixth multi-layer perceptron (MLP), and project the second concatenated feature (obtained by concatenating the first lane segment fused feature, the vehicle interaction feature, and the second lane segment fused feature) into a second key vector K_{l,t} and a second value vector V_{l,t} using a seventh multi-layer perceptron (MLP). Here, l denotes the l-th surrounding vehicle (l=1, 2, . . . ), and the number of channels may be d.

The self-attention mechanism is used to fuse the second lane segment fused feature into the first position sequence feature to obtain the residual feature bᵣₑₛ_{ᵢ}, as shown in Formula 9 below:

bᵣₑₛ_{ᵢ}=att(Q_{i,t}·K_{l,t}) Formula 9;

Further, the trajectory prediction system may concatenate the residual feature bᵣₑₛ_{ᵢ} with the first position sequence feature, followed by normalization and processing by a seventh multi-layer perceptron (MLP), to obtain the target fused feature b′ᵢ, as shown in Formula 10 below:

b′ᵢ=η₂(φ(η₁(bᵢ+bᵣₑₛ_{ᵢ}))+η₁(bᵢ+bᵣₑₛ_{ᵢ})) Formula 10;
where η₁ and η₂ denote normalization functions, and φ denotes the network structure of the seventh multi-layer perceptron (MLP) of the fully-connected layer.

In some embodiments, the vehicle interaction feature mentioned above may be obtained in the following manner: the trajectory prediction system may acquire surrounding vehicle position information of the to-be-predicted vehicle, and process the surrounding vehicle position information based on a fifth multi-layer perceptron (MLP) to obtain the vehicle interaction feature.

Exemplarily, as shown in FIG. 4, the interaction fusing module of the trajectory prediction system may acquire position information of each vehicle surrounding the to-be-predicted vehicle. The position information includes, but is not limited to, the vehicle's historical behavior, attributes, current state, and other information. The interaction fusing module then calculates the relative coordinates of the surrounding vehicle position information with respect to the to-be-predicted vehicle. These relative coordinates may reflect the spatial positional relationship between the to-be-predicted vehicle and the surrounding vehicles. A fifth multi-layer perceptron (MLP) is used to process the relative coordinates, thereby obtaining vehicle interaction features between the to-be-predicted vehicle and the surrounding vehicles. These vehicle interaction features include not only spatial distance information between the to-be-predicted vehicle and the surrounding vehicles but also, through the nonlinear mapping capability of the fifth multi-layer perceptron (MLP), more complex interaction relationships, such as velocity differences and moving directions.

In an implementation, the trajectory prediction system may also construct global interaction encoding using the vehicle interaction features obtained above, along with the position information of the to-be-predicted vehicle and the surrounding vehicles. That is to say, the position information of the to-be-predicted vehicle and the surrounding vehicles, as well as the vehicle interaction features, are integrated into a graph structure, where the to-be-predicted vehicle is taken as a node, and the connections between them as edges. Through a graph neural network (GNN) or other graph processing algorithms, deeper information within the global interaction encoding can be further extracted to support subsequent decision-making, prediction, or optimization tasks.

It should be understood that the embodiments of the present application establish a connection relationship between the to-be-predicted vehicle and surrounding vehicles at the current moment, and extract edge features using embedding representations and relative coordinates, thereby achieving the construction of the global interaction encoding. This method can accurately capture the dynamic interaction relationships among vehicles, providing effective technical support for intelligent processing in fields such as intelligent transportation and autonomous driving.

In the trajectory prediction method provided in the embodiments of the present application, comprehensive consideration of vehicle position features at multiple historical time points (i.e., the first position sequence feature) enables capturing of the vehicle's dynamic driving pattern, so as to predict its future trajectory more accurately. In addition, the introduction of the lane segment sequence feature, namely the positional relationship between the vehicle and surrounding lane segments, provides additional contextual information, helping to more accurately perceive the vehicle's driving environment and further improve prediction accuracy. Furthermore, the trajectory prediction method provided in the embodiments of the present application relies on the vehicle's dynamic driving pattern and its relative position to lane segments, rather than fixed paths or patterns. This enables the model to adapt to different traffic scenarios and road structures. The introduction of the attention mechanism allows the model to dynamically focus on important input features, thereby making more reasonable predictions under different circumstances.

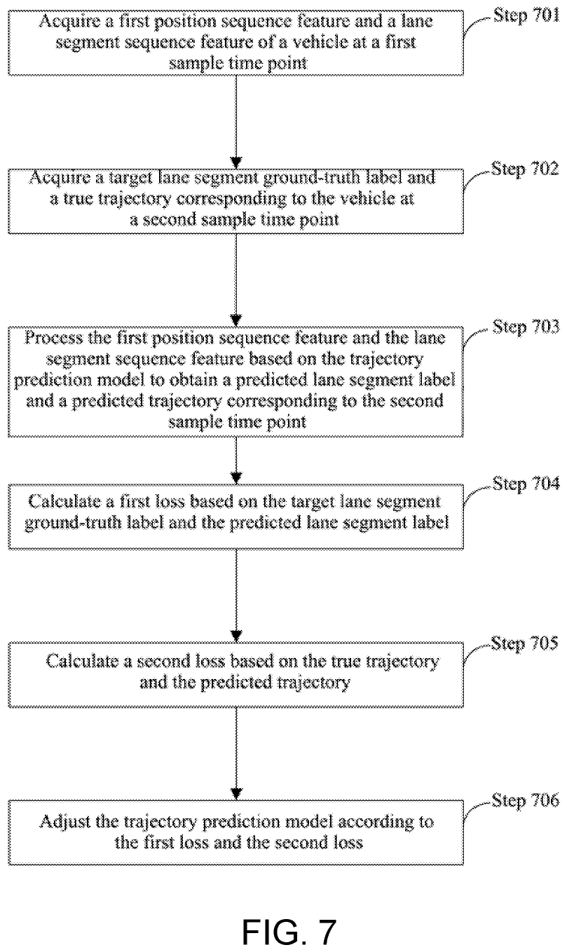

As shown in FIG. 7, an embodiment of the present application provides a training method for a trajectory prediction model, which specifically includes the following steps 701 to 706.

Step 701: acquire a first position sequence feature and a lane segment sequence feature of a vehicle at a first sample time point.

In embodiments related to the present application, the first position sequence feature characterizes positions of the vehicle at a plurality of historical time points before the first sample time point, and the lane segment sequence feature characterizes a positional relationship between the vehicle and surrounding lane segments at the plurality of historical time points.

In some embodiments, historical position information of the vehicle at the plurality of historical time points and surrounding lane segment position information of the to-be-predicted vehicle at the plurality of historical time points are obtained. Based on the trajectory prediction model, the historical position information and the surrounding lane segment position information are processed to obtain the first position sequence feature and the lane segment sequence feature, respectively.

It should be noted that the process of acquiring and processing the historical position information and the surrounding lane segment position information by the trajectory prediction model is the same as that in the trajectory prediction method described above, and will not be repeated here.

Step 702: acquire a target lane segment ground-truth label and a true trajectory corresponding to the vehicle at a second sample time point.

In the embodiments of the present application, a given trajectory prediction dataset may be divided in a ratio of 4:1 to form a training set and a validation set. The training set accounts for 80% of the total data and is used to train the trajectory prediction model. The validation set accounts for 20% of the total data and is used to evaluate the prediction performance of the model. The true trajectories corresponding to the second sample time point of the vehicles already included in the dataset are taken as ground-truth labels for the final prediction output of the trajectory prediction model. It should be understood that these ground-truth labels may be used as supervision information to guide and optimize the training process of the model's prediction task.

Exemplarily, the lane data in the trajectory prediction dataset is preprocessed. In the preprocessing step, screening is conducted based on the current driving direction of the vehicle. That is, surrounding lane segments within a certain distance range along the vehicle's driving direction are retrieved, and these surrounding lane segments may be considered candidate target vectors for the future.

Within the determined distance range, surrounding lane segments that are consistent with the vehicle's driving direction are screened out to form a set of candidate target vectors for the future. Then, within this set of candidate target vectors, the distance between the vehicle's trajectory point at each time point and each surrounding lane segment is calculated, and the nearest surrounding lane segment is selected as the target lane segment label at that time point. These target lane segment labels constitute the ground-truth label set for the target lane segments, which is used to supervise the training of the auxiliary task detection head.

Step 703: process the first position sequence feature and the lane segment sequence feature based on the trajectory prediction model to obtain a predicted lane segment label and a predicted trajectory corresponding to the second sample time point.

In embodiments related to the present application, the trajectory prediction model is configured to perform an attention mechanism operation based on the first position sequence feature and the lane segment sequence feature to obtain a first lane segment fused feature, obtain the predicted trajectory based on the first lane segment fused feature, and determine the predicted lane segment label corresponding to the predicted trajectory.

It should be noted that the process whereby the trajectory prediction model determines the first lane segment fused feature and obtains the predicted trajectory based on the first lane segment fused feature is the same as the process in the trajectory prediction method described above, and will not be repeated here. It should be understood that after the predicted trajectory is obtained, the predicted trajectory along which the vehicle travels will correspond to the corresponding lane segments, and the trajectory prediction model can take those corresponding lane segments as predicted lane segment labels.

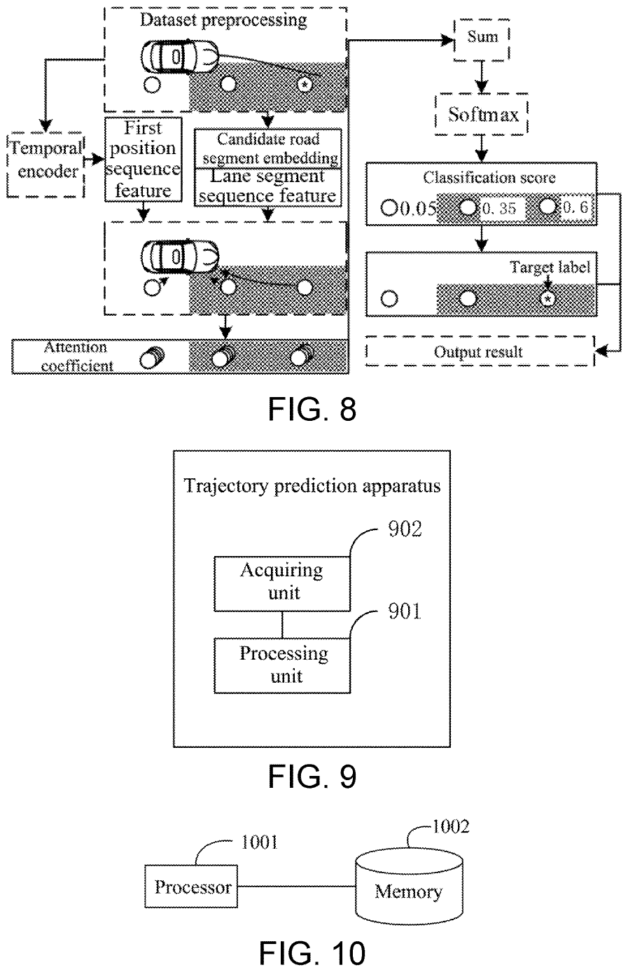

In an implementation, as shown in FIG. 8, the trajectory prediction model may map the first position sequence feature into a third query vector using a multi-layer perceptron (MLP), and map the lane segment sequence feature into a third key vector and a third value vector using a multi-layer perceptron (MLP), as shown in Formula 11 below:

{Q_{i,t}}={(φ_{Q}(e_{i,t})}

{K_{j,t},V_{j,t}}={φ_{K}(e_{j,t}),φ_{V}(e_{j,t})} Formula 11;
where φ_{Q}(e_{i,t}) denotes the third query vector (Query) feature mapped from the first position sequence feature, φ_{K}(e_{j,t}) denotes the third key vector (Key) feature mapped from the lane segment sequence feature, and φ_{V}(e_{j,t}) denotes the third value vector (Value) feature mapped from the lane segment sequence feature.

The third key vector, third value vector, and third query vector are processed through a multi-head cross-attention mechanism to determine the lane segment with the highest classification score in the lane segment set as the predicted lane segment. That is, the multi-head cross-attention mechanism is used to calculate the multi-head attention coefficient of the vehicle toward surrounding lane segments at each historical time point, as shown in Formula 12 below:

$${α}_{i , j , t} = cross\_attn ( {Q}_{i , t}^{T} , {K}_{j , t} , {V}_{j , t} ) ; \qquad Formula 12$$

where α_{i,j,t} denotes the cross-attention coefficient, cross_attn denotes the single-head cross-attention computation function,

$${Q}_{i , t}^{T}$$

denotes the transpose of the first position sequence feature of the i-th vehicle at time t, and K_{j,t} and V_{j,t} denote the lane segment sequence feature at time t, respectively.

Further, sum the cross-attention coefficient corresponding to each head, and then normalize the summation result using the Softmax function. It should be understood that this step is used to calculate the classification score μ_(j,t_f) for each lane segment at the second sample time point based on the attention weight of each head.

Using the target lane segment label at each time point, the classification score of the target lane segment corresponding to the target lane segment label is selected from the computed classification scores. This step ensures consistency between the classification score for subsequent loss calculation and the true lane segment target.

In some embodiments, the trajectory prediction model may acquire a vehicle interaction feature of the vehicle and a second lane segment fused feature corresponding to a surrounding vehicle of the vehicle.

The vehicle interaction feature is used to characterize a positional relationship between the vehicle and surrounding vehicles at the first sample time point.

It should be noted that the process of acquiring the vehicle interaction feature and the second lane segment fused feature described above is the same as the process of acquiring the vehicle interaction feature and the second lane segment fused feature in the trajectory prediction method, and will not be repeated here.

In some embodiments, the first lane segment fused feature, the vehicle interaction feature, and the second lane segment fused feature are processed based on the trajectory prediction model to obtain the predicted lane segment label and the predicted trajectory corresponding to the second sample time point.

Among them, the trajectory prediction model is configured to perform an attention mechanism operation based on the first position sequence feature and the lane segment sequence feature to obtain the first lane segment fused feature, perform an attention mechanism operation based on the first lane segment fused feature, the vehicle interaction feature, and the second lane segment fused feature to obtain a target fused feature, generate the predicted trajectory of the vehicle according to the target fused feature, and determine the predicted lane segment label corresponding to the predicted trajectory.

It should be noted that the process whereby the trajectory prediction model determines the first lane segment fused feature and the target fused feature, and obtains the predicted trajectory based on the target fused feature, is the same as the process in the trajectory prediction method described above, and will not be repeated here. It should be understood that after the predicted trajectory is obtained, the predicted trajectory along which the vehicle travels will correspond to the corresponding lane segments, and the trajectory prediction model can take those corresponding lane segments as predicted lane segment labels.

Step 704: calculate a first loss based on the target lane segment ground-truth label and the predicted lane segment label.

In some embodiments, based on the selected classification score of the target lane segment, a binary cross entropy (BCE_loss) is used as the loss function to calculate the training loss for the auxiliary task. This loss function measures the error between the classification scores predicted by the model and actual target lane points, thereby guiding the training process of the model.

Exemplarily, the target lane segment ground-truth label is matched with the predicted lane segment label, for example, based on temporal or spatial dimension to ensure that the comparison is made at the same time point or spatial position. The difference between the matched target lane segment ground-truth label and the predicted lane segment label is then calculated. This difference includes, but is not limited to, positional deviation, directional deviation, width deviation, etc., of the lane segment.

Further, based on the above differences, a first loss function loss_{goal}, i.e., the cross-entropy goal classification loss (denoted as loss_goal), is calculated. This loss function aims to quantify the degree of inconsistency between the predicted lane segment label and the target lane segment ground-truth label, and may typically employ mathematical distance metrics (such as Euclidean distance, Manhattan distance, etc.) or probabilistic metrics (such as cross-entropy loss, KL divergence, etc.).

It should be understood that the calculation result of the first loss function reflects the accuracy of the model's prediction; that is, the smaller the difference between the lane segment predicted by the model and the actual lane segment, the better the prediction performance of the model.

Step 705: calculate a second loss based on the true trajectory and the predicted trajectory.

Exemplarily, time synchronization or spatial alignment is performed between the true trajectory and the predicted trajectory to ensure that the comparison is made at the same time point or spatial position. For example, an appropriate metric is used to calculate the difference between the true trajectory and the predicted trajectory. This difference includes, but is not limited to, differences of trajectories in geometric shape (such as path length, curvature, etc.), differences of trajectories in dynamic characteristics (such as changes in velocity, acceleration, etc.), and differences of trajectories in time synchronization (such as time delay, time interval, etc.).

Based on the above differences, a second loss function is calculated. This second loss function aims to quantify the degree of inconsistency between the predicted trajectory and the true trajectory. Typically, it employs mathematical distance metrics (such as Euclidean distance, Manhattan distance, Fréchet distance, etc.), dynamic characteristic metrics (such as velocity error, acceleration error, etc.), or time synchronization metrics (such as time delay loss, etc.). In another example, a SmoothL1 regression loss (loss_reg) is calculated for the predicted trajectory and the true trajectory, and a second loss function loss_cls (cross-entropy classification loss) is calculated for the predicted trajectory. This cross-entropy classification loss aims to increase the confidence corresponding to the mode, making it more accurately reflect the true situation.

Step 706: adjust the trajectory prediction model according to the first loss and the second loss.

Exemplarily, the calculated first loss and second loss are fused to form a joint loss function. This can be achieved, for example, by simple weighted summation, multiplication, or other complex nonlinear combinations. The joint loss function aims to comprehensively reflect the model's performance in both lane segment prediction and trajectory prediction.

Further, gradient descent or other optimization algorithms are used to adjust the parameters of the trajectory prediction model based on the gradient information of the joint loss function. During the adjustment process, the model continuously attempts to reduce the joint loss, thereby gradually improving the accuracy of lane segment prediction and trajectory prediction.

It should be understood that during the model training phase, the adjusted model can be iteratively trained on a dataset containing diverse scenarios, while continuously monitoring the changes in the joint loss. Through continuous parameter adjustment and optimization, the model gradually converges to the optimal solution.

During the model validation phase, an independent validation dataset is used to evaluate the performance of the trained model. By comparing the difference between the model's prediction results on the validation set and the actual data, the generalization ability and prediction accuracy of the model are verified. Based on the validation results, the model is further optimized and adjusted.

In another example, the final training loss function loss_total is a linear combination of the first loss function loss_{goal}, the SmoothL1 regression loss loss_reg, and the second loss function loss_cls. Specifically, loss_total can be calculated as shown in Formula 13:

loss_total=(1−α)[β·loss_cls+(1−β)·loss_reg]+α·loss_goal Formula 13;
where the linear coefficients α and β are set to 0.2 and 0.5, respectively, to balance the influence of different loss terms and achieve the effect of using lane target prediction to assist trajectory prediction. During the training process, the embodiments of the present application use backpropagation techniques in neural network model training to iteratively update the model parameters. By continuously adjusting the model's parameters, the computed value of the loss function loss_total is progressively reduced. When the computed value of the loss function falls below a certain threshold, the model is considered to have been trained to an optimal state, at which point it possesses high prediction accuracy and reliability.

The foregoing primarily introduces the solutions provided by the embodiments of the present application from a method perspective. To implement the above functions, an trajectory prediction apparatus or an electronic device includes corresponding hardware structures and/or software modules for executing each function. Those skilled in the art should readily appreciate that, in combination with the units and algorithm steps of the examples described in the embodiments disclosed herein, the present application can be implemented in hardware or a combination of hardware and computer software. Whether a particular function is executed in hardware or computer software-driven hardware depends on the specific application and design constraints of the technical solution. Skilled professionals may use different methods for each specific application to implement the described functions, but such implementations should not be considered beyond the scope of the present application.

The embodiments of the present application may, based on the above methods, illustratively divide the functional modules of the trajectory prediction apparatus or electronic device. For example, the trajectory prediction apparatus or electronic device may include various functional modules corresponding to different functions, or two or more functions may be integrated into one processing module. The above-mentioned integrated modules may be implemented either in the form of hardware or software functional modules. It should be noted that the division of modules in the embodiments of the present application is schematic and merely a logical functional division. In actual implementation, other division methods may be used.

FIG. 9 is a block diagram of another trajectory prediction apparatus according to an exemplary embodiment. The trajectory prediction apparatus can be applied to a trajectory prediction method or a training method. Referring to FIG. 9, the trajectory prediction apparatus includes: a processing unit 901 and an acquiring unit 902. The acquiring unit 902 is configured to acquire a first position sequence feature and a lane segment sequence feature of a to-be-predicted vehicle, where the first position sequence feature is used to characterize position features of the to-be-predicted vehicle at a plurality of historical time points, and the lane segment sequence feature is used to characterize a positional relationship between the to-be-predicted vehicle and surrounding lane segments. The processing unit 901 is configured to perform an attention mechanism operation based on the first position sequence feature and the lane segment sequence feature to obtain a first lane segment fused feature. The processing unit 901 is further configured to obtain a predicted trajectory of the to-be-predicted vehicle based on the first lane segment fused feature.

In some embodiments, the processing unit 901 is specifically configured to: acquire a vehicle interaction feature and a second lane segment fused feature corresponding to a surrounding vehicle of the to-be-predicted vehicle, where the vehicle interaction feature is used to characterize a positional relationship between the to-be-predicted vehicle and the surrounding vehicle; perform an attention mechanism operation based on the first lane segment fused feature, the vehicle interaction feature, and the second lane segment fused feature to obtain a target fused feature; and generate the predicted trajectory of the to-be-predicted vehicle according to the target fused feature.

In some embodiments, the processing unit 901 is specifically configured to: acquire historical position information of the to-be-predicted vehicle; process the historical position information based on a first multi-layer perceptron (MLP) to obtain a second position sequence feature of the to-be-predicted vehicle; fuse the second position sequence feature with a time embedding parameter to obtain a third position sequence feature; and perform an attention mechanism operation on the third position sequence feature to obtain the first position sequence feature.

In some embodiments, the processing unit 901 is specifically configured to: acquire surrounding lane segment position information of the to-be-predicted vehicle; and process the surrounding lane segment position information based on a second multi-layer perceptron (MLP) to obtain the lane segment sequence feature.

In some embodiments, the processing unit 901 is specifically configured to: map the first position sequence feature into a first query vector based on a third multi-layer perceptron (MLP); map a first concatenated feature into a first key vector and a first value vector based on a fourth multi-layer perceptron (MLP), where the first concatenated feature is obtained by concatenating the first position sequence feature and the lane segment sequence feature; and perform the attention mechanism operation based on the first query vector, the first key vector and the first value vector to obtain the first lane segment fused feature.

In some embodiments, the processing unit 901 is specifically configured to acquire surrounding vehicle position information of the to-be-predicted vehicle; and process the surrounding vehicle position information based on a fifth multi-layer perceptron (MLP) to obtain vehicle interaction features.

In some embodiments, the processing unit 901 is specifically configured to map the first lane segment fused feature into a second query vector based on a sixth multi-layer perceptron (MLP); map a second concatenated feature into a second key vector and a second value vector based on a seventh multi-layer perceptron (MLP), where the second concatenated feature is obtained by concatenating the first lane segment fused feature, the vehicle interaction feature, and the second lane segment fused feature; and perform the attention mechanism operation based on the second query vector, the second key vector, and the second value vector to obtain the target fused feature.

The acquiring unit 902 is further configured to acquire a first position sequence feature and a lane segment sequence feature of the vehicle at a first sample time point, where the first position sequence feature characterizes positions of the vehicle at a plurality of historical time points before the first sample time point, and the lane segment sequence feature characterizes a positional relationship between the vehicle and surrounding lane segments at the plurality of historical time points. The acquiring unit 902 is further configured to acquire a target lane segment ground-truth label and a true trajectory corresponding to the vehicle at a second sample time point. The processing unit 901 is further configured to process the first position sequence feature and the lane segment sequence feature based on a trajectory prediction model to obtain a predicted lane segment label and a predicted trajectory corresponding to the second sample time point. The trajectory prediction model is configured to perform an attention mechanism operation based on the first position sequence feature and the lane segment sequence feature to obtain a first lane segment fused feature, obtain the predicted trajectory based on the first lane segment fused feature, and determine the predicted lane segment label corresponding to the predicted trajectory; calculate a first loss based on the target lane segment ground-truth label and the predicted lane segment label; calculate a second loss based on the true trajectory and the predicted trajectory; and adjust the trajectory prediction model according to the first loss and the second loss.

In some embodiments, the processing unit 901 is specifically configured to: acquire historical position information of the vehicle at the plurality of historical time points and surrounding lane segment position information of the to-be-predicted vehicle at the plurality of historical time points; and process the historical position information and the surrounding lane segment position information based on the trajectory prediction model to obtain the first position sequence feature and the lane segment sequence feature, respectively.

In some embodiments, the processing unit 901 is further configured to: acquire a vehicle interaction feature of the vehicle and a second lane segment fused feature corresponding to a surrounding vehicle of the vehicle, where the vehicle interaction feature is used to characterize a positional relationship between the vehicle and the surrounding vehicle at the first sample time point. Processing the first position sequence feature and the lane segment sequence feature based on the trajectory prediction model to obtain the predicted lane segment label and the predicted trajectory corresponding to the second sample time point includes: processing the first lane segment fused feature, the vehicle interaction feature, and the second lane segment fused feature based on the trajectory prediction model to obtain the predicted lane segment label and the predicted trajectory corresponding to the second sample time point, where the trajectory prediction model is configured to perform an attention mechanism operation based on the first position sequence feature and the lane segment sequence feature to obtain the first lane segment fused feature, perform an attention mechanism operation based on the first lane segment fused feature, the vehicle interaction feature, and the second lane segment fused feature to obtain a target fused feature, generate the predicted trajectory of the vehicle according to the target fused feature, and determine the predicted lane segment label corresponding to the predicted trajectory.

Regarding the apparatus in the above embodiments, the specific manner in which each module performs operations has been described in detail in the embodiments related to the method, and will not be elaborated further here.

FIG. 10 is a block diagram of an electronic device according to an exemplary embodiment. As shown in FIG. 10, the electronic device includes, but is not limited to: a processor 1001 and a memory 1002.

The above-mentioned memory 1002 is used to store executable instructions for the above-mentioned processor 1001. It can be understood that the above-mentioned processor 1001 is configured to execute the instructions to implement the trajectory prediction method or training method for a trajectory prediction method in the above embodiments.

It should be noted that those skilled in the art will understand that the structure of the electronic device shown in FIG. 10 does not constitute a limitation on the electronic device. The electronic device may include more or fewer components than those shown in FIG. 10, or combine certain components, or have a different arrangement of components.

The processor 1001 is the control center of the electronic device. It connects various parts of the entire electronic device using various interfaces and lines. By running or executing software programs and/or modules stored in the memory 1002, and calling data stored in the memory 1002, it performs various functions of the electronic device and processes data, so as to realize overall monitoring of the electronic device. The processor 1001 may include one or more processing units. In an implementation, the processor 1001 may integrate an application processor and a modem processor, where the application processor primarily handles the operating system, user interface, and application programs, while the modem processor primarily handles wireless communication. It can be understood that the above-mentioned modem processor may also not be integrated into the processor 1001.

The memory 1002 may be used to store software programs and various data. The memory 1002 may primarily include a program storage area and a data storage area. The program storage area may store an operating system and application programs required by at least one functional module (such as an acquiring unit, a processing unit, etc.). In addition, the memory 1002 may include high-speed random access memory, and may also include non-volatile memory, such as at least one magnetic disk storage device, flash memory device, or other volatile solid-state storage device.

In an exemplary embodiment, a computer-readable storage medium including instructions is also provided, such as the memory 1002 including instructions. The instructions can be executed by the processor 1001 of the electronic device to implement the methods in the above embodiments.

In actual implementation, the functions of the acquiring unit 902, and the processing unit 901 in FIG. 9 can all be implemented by the processor 1001 in FIG. 10 calling computer programs stored in the memory 1002. For the specific execution process, reference may be made to the description of the method part in the above embodiments, and details will not be repeated here.

In an implementation, the computer-readable storage medium may be a non-transitory computer-readable storage medium. For example, the non-transitory computer-readable storage medium may be a read-only memory (ROM), random access memory (RAM), CD-ROM, magnetic tape, floppy disk, optical data storage device, or the like.

In an exemplary embodiment, the embodiments of the present application further provide a computer program product including one or more instructions. The one or more instructions may be executed by the processor 1001 of the electronic device to perform the methods in the above embodiments.

It should be noted that when the instructions in the above-mentioned computer-readable storage medium or the one or more instructions in the computer program product are executed by the processor of the electronic device, they implement the various processes of the above-mentioned method embodiments and achieve the same technical effects as the above-mentioned methods. To avoid repetition, they will not be described again here.

From the description of the above implementations, those skilled in the art can clearly understand that for the convenience and brevity of description, only the division of the above functional modules is used as an example. In actual applications, the above functions can be assigned to different functional modules as needed, that is, the internal structure of the device is divided into different functional modules to complete all or part of the functions described above.

In the several embodiments provided in the present application, it should be understood that the disclosed apparatus and methods may be implemented in other ways. For example, the apparatus embodiments described above are merely illustrative. For instance, the division of modules or units is only a logical functional division, and in actual implementation, other division manners may be adopted. For example, multiple units or components may be combined or integrated into another apparatus, or some features may be omitted or not executed. Additionally, the mutual couplings, direct couplings, or communication connections shown or discussed may be implemented through some interfaces, indirect couplings, or communication connections between apparatuses or units, which may be electrical, mechanical, or other forms.

Units described as separate components may or may not be physically separate. Components shown as units may be one physical unit or multiple physical units, i.e., they may be located in one place or distributed across multiple different places. Some or all of the units may be selected according to actual needs to achieve the objectives of the solutions of the present embodiments.

In addition, the functional units in the various embodiments of the present application may be integrated into one processing unit, or each unit may exist physically independently, or two or more units may be integrated into one unit. The above-mentioned integrated units may be implemented in the form of hardware or in the form of software functional units.

If an integrated unit is implemented in the form of a software functional unit and sold or used as an independent product, it may be stored in a readable storage medium. Based on such an understanding, the technical solutions of the embodiments of the present application, in essence, or the part that contributes to the prior art, or part or all of the technical solutions, may be embodied in the form of a software product. The software product is stored in a storage medium and includes several instructions for causing a device (which may be a microcontroller, a chip, etc.) or a processor to execute all or part of the steps of the methods described in the various embodiments of the present application. The aforementioned storage medium includes various media that can store program codes, such as a USB flash drive, a removable hard disk, ROM, RAM, a magnetic disk, or an optical disc.

The above are merely specific implementations of the present application, but the protection scope of the present application is not limited thereto. Any changes or substitutions within the technical scope disclosed in the present application shall be covered by the protection scope of the present application. Therefore, the protection scope of the present application shall be subject to the protection scope of the claims.

What is claimed is:

1. A trajectory prediction method, wherein the method comprises:
acquiring a first position sequence feature and a lane segment sequence feature of a to-be-predicted vehicle; the first position sequence feature being used to characterize position features of the to-be-predicted vehicle at a plurality of historical time points; the lane segment sequence feature being used to characterize a positional relationship between the to-be-predicted vehicle and surrounding lane segments;
performing an attention mechanism operation based on the first position sequence feature and the lane segment sequence feature to obtain a first lane segment fused feature;
obtaining a predicted trajectory of the to-be-predicted vehicle based on the first lane segment fused feature.

2. The method according to claim 1, wherein obtaining the predicted trajectory of the to-be-predicted vehicle based on the first lane segment fused feature comprises:
acquiring a vehicle interaction feature and a second lane segment fused feature corresponding to a surrounding vehicle of the to-be-predicted vehicle; the vehicle interaction feature being used to characterize a positional relationship between the to-be-predicted vehicle and the surrounding vehicle;
performing an attention mechanism operation based on the first lane segment fused feature, the vehicle interaction feature, and the second lane segment fused feature to obtain a target fused feature;
generating the predicted trajectory of the to-be-predicted vehicle according to the target fused feature.

3. The method according to claim 1, wherein acquiring the first position sequence feature of the to-be-predicted vehicle comprises:
acquiring historical position information of the to-be-predicted vehicle;
processing the historical position information based on a first multi-layer perceptron to obtain a second position sequence feature of the to-be-predicted vehicle;
fusing the second position sequence feature with a time embedding parameter to obtain a third position sequence feature;
performing an attention mechanism operation on the third position sequence feature to obtain the first position sequence feature.

4. The method according to claim 2, wherein acquiring the first position sequence feature of the to-be-predicted vehicle comprises:
acquiring historical position information of the to-be-predicted vehicle;
processing the historical position information based on a first multi-layer perceptron to obtain a second position sequence feature of the to-be-predicted vehicle;
fusing the second position sequence feature with a time embedding parameter to obtain a third position sequence feature;
performing an attention mechanism operation on the third position sequence feature to obtain the first position sequence feature.

5. The method according to claim 1, wherein acquiring the lane segment sequence feature of the to-be-predicted vehicle comprises:
acquiring surrounding lane segment position information of the to-be-predicted vehicle;
processing the surrounding lane segment position information based on a second multi-layer perceptron MLP to obtain the lane segment sequence feature.

6. The method according to claim 2, wherein acquiring the lane segment sequence feature of the to-be-predicted vehicle comprises:
acquiring surrounding lane segment position information of the to-be-predicted vehicle;
processing the surrounding lane segment position information based on a second multi-layer perceptron MLP to obtain the lane segment sequence feature.

7. The method according to claim 1, wherein performing the attention mechanism operation based on the first position sequence feature and the lane segment sequence feature to obtain the first lane segment fused feature comprises:
mapping the first position sequence feature into a first query vector based on a third multi-layer perceptron;
mapping a first concatenated feature into a first key vector and a first value vector based on a fourth multi-layer perceptron; the first concatenated feature being obtained by concatenating the first position sequence feature and the lane segment sequence feature;
performing the attention mechanism operation based on the first query vector, the first key vector and the first value vector to obtain the first lane segment fused feature.

8. The method according to claim 2, wherein performing the attention mechanism operation based on the first position sequence feature and the lane segment sequence feature to obtain the first lane segment fused feature comprises:
mapping the first position sequence feature into a first query vector based on a third multi-layer perceptron;
mapping a first concatenated feature into a first key vector and a first value vector based on a fourth multi-layer perceptron; the first concatenated feature being obtained by concatenating the first position sequence feature and the lane segment sequence feature;
performing the attention mechanism operation based on the first query vector, the first key vector and the first value vector to obtain the first lane segment fused feature.

9. The method according to claim 2, wherein acquiring the vehicle interaction feature comprises:
acquiring surrounding vehicle position information of the to-be-predicted vehicle;
processing the surrounding vehicle position information based on a fifth multi-layer perceptron to obtain the vehicle interaction feature.

10. The method according to claim 2, wherein performing the attention mechanism operation based on the first lane segment fused feature, the vehicle interaction feature, and the second lane segment fused feature to obtain the target fused feature comprises:
mapping the first lane segment fused feature into a second query vector based on a sixth multi-layer perceptron;
mapping a second concatenated feature into a second key vector and a second value vector based on a seventh multi-layer perceptron; the second concatenated feature being obtained by concatenating the first lane segment fused feature, the vehicle interaction feature, and the second lane segment fused feature;
performing the attention mechanism operation based on the second query vector, the second key vector, and the second value vector to obtain the target fused feature.

11. The method according to claim 9, wherein performing the attention mechanism operation based on the first lane segment fused feature, the vehicle interaction feature, and the second lane segment fused feature to obtain the target fused feature comprises:
mapping the first lane segment fused feature into a second query vector based on a sixth multi-layer perceptron;
mapping a second concatenated feature into a second key vector and a second value vector based on a seventh multi-layer perceptron; the second concatenated feature being obtained by concatenating the first lane segment fused feature, the vehicle interaction feature, and the second lane segment fused feature;
performing the attention mechanism operation based on the second query vector, the second key vector, and the second value vector to obtain the target fused feature.

12. A training method for a trajectory prediction model, wherein the method comprises:
acquiring a first position sequence feature and a lane segment sequence feature of a vehicle at a first sample time point; the first position sequence feature characterizing positions of the vehicle at a plurality of historical time points before the first sample time point; the lane segment sequence feature characterizing a positional relationship between the vehicle and surrounding lane segments at the plurality of historical time points;
acquiring a target lane segment ground-truth label and a true trajectory corresponding to the vehicle at a second sample time point;
processing the first position sequence feature and the lane segment sequence feature based on the trajectory prediction model to obtain a predicted lane segment label and a predicted trajectory corresponding to the second sample time point; the trajectory prediction model being configured to perform an attention mechanism operation based on the first position sequence feature and the lane segment sequence feature to obtain a first lane segment fused feature, obtain the predicted trajectory based on the first lane segment fused feature, and determine the predicted lane segment label corresponding to the predicted trajectory;
calculating a first loss based on the target lane segment ground-truth label and the predicted lane segment label;
calculating a second loss based on the true trajectory and the predicted trajectory;
adjusting the trajectory prediction model according to the first loss and the second loss.

13. The method according to claim 12, wherein acquiring the first position sequence feature and the lane segment sequence feature of the vehicle at the first sample time point comprises:
acquiring historical position information of the vehicle at the plurality of historical time points and surrounding lane segment position information of a to-be-predicted vehicle at the plurality of historical time points;
processing the historical position information and the surrounding lane segment position information based on the trajectory prediction model to obtain the first position sequence feature and the lane segment sequence feature, respectively.

14. The method according to claim 12, wherein the method further comprises:
acquiring a vehicle interaction feature of the vehicle and a second lane segment fused feature corresponding to a surrounding vehicle of the vehicle; the vehicle interaction feature being used to characterize a positional relationship between the vehicle and the surrounding vehicle at the first sample time point;
wherein processing the first position sequence feature and the lane segment sequence feature based on the trajectory prediction model to obtain the predicted lane segment label and the predicted trajectory corresponding to the second sample time point, comprises:
processing the first lane segment fused feature, the vehicle interaction feature, and the second lane segment fused feature based on the trajectory prediction model to obtain the predicted lane segment label and the predicted trajectory corresponding to the second sample time point; the trajectory prediction model being configured to perform an attention mechanism operation based on the first position sequence feature and the lane segment sequence feature to obtain the first lane segment fused feature, perform an attention mechanism operation based on the first lane segment fused feature, the vehicle interaction feature, and the second lane segment fused feature to obtain a target fused feature, generate the predicted trajectory of the vehicle according to the target fused feature, and determine the predicted lane segment label corresponding to the predicted trajectory.

15. The method according to claim 13, wherein the method further comprises:
acquiring a vehicle interaction feature of the vehicle and a second lane segment fused feature corresponding to a surrounding vehicle of the vehicle; the vehicle interaction feature being used to characterize a positional relationship between the vehicle and the surrounding vehicle at the first sample time point;
wherein processing the first position sequence feature and the lane segment sequence feature based on the trajectory prediction model to obtain the predicted lane segment label and the predicted trajectory corresponding to the second sample time point, comprises:
processing the first lane segment fused feature, the vehicle interaction feature, and the second lane segment fused feature based on the trajectory prediction model to obtain the predicted lane segment label and the predicted trajectory corresponding to the second sample time point; the trajectory prediction model being configured to perform an attention mechanism operation based on the first position sequence feature and the lane segment sequence feature to obtain the first lane segment fused feature, perform an attention mechanism operation based on the first lane segment fused feature, the vehicle interaction feature, and the second lane segment fused feature to obtain a target fused feature, generate the predicted trajectory of the vehicle according to the target fused feature, and determine the predicted lane segment label corresponding to the predicted trajectory.

16. An electronic device, comprising:
a processor;
a memory for storing instructions executable by the processor;
wherein the processor is configured to execute the instructions to implement the method according to claim 1.

17. An electronic device, comprising:
a processor;
a memory for storing instructions executable by the processor;
wherein the processor is configured to execute the instructions to implement the method according to claim 12.

18. A vehicle, wherein the vehicle comprises the electronic device according to claim 16.

19. A non-transitory computer-readable storage medium, wherein when computer-executable instructions stored in the computer-readable storage medium are executed by a processor of an electronic device, the electronic device is capable of performing the method according to claim 1.

20. A non-transitory computer-readable storage medium, wherein when computer-executable instructions stored in the computer-readable storage medium are executed by a processor of an electronic device, the electronic device is capable of implementing the method according to claim 12.
